(19) United States
(12) Patent Application Publication
(10) Pub. No.: US 2015/0179049 A1
(43) Pub. Date: Jun. 25, 2015

(54) NOTIFICATION ASSEMBLY, METHOD OF USING AND MAKING THE SAME

(71) Applicants: Farlin Franusich, Colorado Springs, CO (US); Kelsey Franusich, Colorado Springs, CO (US); Nicholas Vergunst, Colorado Springs, CO (US)

(72) Inventors: Farlin Franusich, Colorado Springs, CO (US); Kelsey Franusich, Colorado Springs, CO (US); Nicholas Vergunst, Colorado Springs, CO (US)

(21) Appl. No.: 14/577,768

(22) Filed: Dec. 19, 2014

Related U.S. Application Data
(60) Provisional application No. 61/919,223, filed on Dec. 20, 2013.

(51) Int. Cl. G08B 25/01; G08B 3/10; G08B 5/22

(52) U.S. Cl. CPC G08B 25/016; G08B 5/222; G08B 3/1008

(57) ABSTRACT

A notification assembly includes an input interface including capacitive switches and an output interface including corresponding indicators to the capacitive switches. The capacitive switches each include a touchpad available to receive a touch from a user indicating an input of the capacitive switch. The touch disturbing an electric field generated within the capacitive switch by affecting a fringe field of the electric field over the touchpad. The disturbed electric field is measured and processed by a processor and changing an output indicators of an output interface indicating activation states of the indicators.

### CROSS REFERENCE TO RELATED APPLICATIONS

The present application claims the benefit of U.S. Provisional Patent Application 61/919,223, filed Dec. 20, 2013; the above-identified application being fully incorporated herein by reference.

### BACKGROUND OF THE INVENTION

### Field of the Invention

The invention generally relates to a notification device, and more particularly to a method and system for providing one or more preprogrammed notifications from a first user to a second user.

### SUMMARY OF THE INVENTION

Accordingly, the invention is directed to a notification assembly, and a method of making and using the same that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a notification assembly includes an input interface including one or more capacitive switches, an output interface including one or more indicators each corresponding to one of the capacitive switches, and a processor coupled to the capacitive switches and the indicators and configured to process an input of the capacitive switches and send an output to the indicators. The input interface is placed at a distance from the output interface. In another configuration, the processor is configured to process a reversal of the activation state of the output by a pattern of the input of the capacitive switches over a time period. The pattern is representative of an intentional act of a user over an input of the capacitive switches. In another configuration, the processor is configured to process an activation state of the output by a pattern of the input of the capacitive switches over a time period.

In one configuration, each of the capacitive switches includes a signal generator configured for generating an electric field about an electromagnetic signal radiator. The electric field includes a fringe field. Each of the capacitive switches also includes a signal monitor configured for measuring a disturbance of the electric field. In another configuration, each of the capacitive switches further includes a touchpad separated into an inner portion and an outer portion by a separator. The outer portion is accessible to a user. The electric field is substantially generated within the inner portion, and wherein the fringe field is substantially within the outer portion. In another configuration, each of the capacitive switches further includes an analog-to-digital convertor (ADC) configured for converting a measurement of the electric field by the signal monitor into a digital signal. The digital signal is used by the processor as the input of the each of the capacitive switches. In another configuration, the fringe field is disturbed by a capacitive sink. In another configuration, the capacitive sink includes one of a finger of a user, an electronic stylus, or a conductive glove.

In one configuration, the input interface is placed at an interior of a room. The output interface is placed at an exterior of the room.

In another embodiment, a method of notification includes receiving an input from one or more capacitive switches of an input interface, processing, using a processor coupled to the capacitive switches, the input of the capacitive switches, and transmitting, using the processor. An output to one or more indicators of an output is based on and corresponding to the input of the capacitive switches. The input interface is placed at a distance from the output interface. In another configuration, the input interface is placed at an interior of a room, and wherein the output interface is placed at an exterior of the room.

In one configuration, the receiving the input from the capacitive switches includes generating an electric field, by a signal generator, about an electromagnetic signal radiator. The electric field includes a fringe field. The receiving the input from the capacitive switches also includes measuring a disturbance of the electric field using a signal monitor. In another configuration, the each of the capacitive switches further includes a touchpad separated into an inner portion and an outer portion by a separator. The outer portion is accessible to a user. The electric field is substantially generated within the inner portion. The fringe field is substantially within the outer portion. In another configuration, the fringe field is disturbed by a capacitive sink. In another configuration, the receiving the input from the capacitive switches further includes converting a measurement of the disturbance of the electric field by the signal monitor into a digital signal. The digital signal is used by the processor as the input of the each of the capacitive switches. In another configuration, the capacitive sink includes a finger of a user, an electronic stylus, or a conductive glove.

In one configuration, the processing, by the processor, includes processing a reversal of the activation state of the output by a pattern of the input of the capacitive switches over a time period. The pattern is representative of an intentional act of a user over an input of the capacitive switches. In another configuration, the processing, by the processor, further includes processing a reversal of the activation state of the output by a pattern of the input of the capacitive switches over a time period representative of a touch of a finger over an input of the capacitive switches.

In another embodiment, a notification assembly includes an input interface including one or more capacitive switches, an output interface including one or more indicators each corresponding to one of the capacitive switches, and a processor coupled to the capacitive switches and the indicators and configured to process an input of the capacitive switches and send an output to the indicators. The input interface is placed at a distance from the output interface. Each of the capacitive switches includes a touchpad separated into an inner portion and an outer portion by a separator. The outer portion is accessible to a user. The electric field is substantially generated within the inner portion. The fringe field is substantially within the outer portion. The each of the capacitive switches further includes a signal generator configured for generating an electric field about an electromagnetic signal radiator, the electric field includes a fringe field, a signal monitor configured for measuring a disturbance the electric field, and an analog-to-digital convertor (ADC) configured for converting a measurement of the disturbance of the electric field by the signal monitor into a digital signal. The digital signal is used by the processor as the input of the each of the capacitive switches. In another configuration, the input interface is placed at an interior of a room, and wherein the output interface is placed at an exterior of the room.

It is to be understood that both the foregoing general description and the following detailed description are exemplary and explanatory and are intended to provide further explanation of the invention as claimed.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A illustrates an exemplary view of a first interface of a notification assembly according to an embodiment of the invention;

FIG. 1B illustrates an exemplary view of a second interface of a notification assembly according to an embodiment of the invention;

FIG. 2 illustrates an exemplary view of an input for a notification assembly according to an embodiment of the invention;

FIG. 3 illustrates an exemplary schematic of a notification assembly according to an embodiment of the invention;

FIG. 4 illustrates an exemplary schematic of a capacitive switch for a notification assembly according to an embodiment of the invention; and

FIG. 5 illustrates an exemplary schematic of a capacitive switch for a notification assembly according to an embodiment of the invention.

### DETAILED DESCRIPTION OF THE ILLUSTRATED EMBODIMENTS

In order to more fully appreciate the present disclosure and to provide additional related features, the following references are incorporated herein by reference in their entirety:

(1) U.S. Pat. No. 2,343,009 by J. A. Hall which relates to a signal device particularly adapted to use in the situation of ordinary front door bell push-buttons, and arranged to convey information to a person operating the push-button, or to operate a signal, such as bells or chimes.

(2) U.S. Pat. No. 2,434,442 by W. E. Stanfield which relates to a combined electrical indicator and note receptacle for doors. It consists of the combinations, constructions and arrangement of parts to provide an electrical indicator, which may be set manually by the occupants of a house, in such a manner as to indicate to a caller the presence or absence of the occupants when the caller actuates the push button of a door bell.

(3) U.S. Pat. No. 2,487,541 by Gustin which discloses a door signal apparatus and has for an object the provision of a small, simple and inexpensively constructed push button casing for use at an entry door for actuating an interiorly disposed chime or the like, the push button casing containing an illuminable annunciator plate normally serving as a name card for the occupant and selectively arranged for electrical actuation to display an “Out” signal.

(4) U.S. Pat. No. 2,631,394 by Sopocko which relates to illuminated signs, the primary object of the invention being to provide an illuminated sign which may be either in the form of a house number, advertising sign or the like, which is so constructed and arranged that while indicia on the sign will be clearly visible by person moving in proximity to the sign, the indicia of the sign will be obscured from view from points above the sign, thereby shielding the light rays from the sign and preventing the light rays from consitituting an illuminated target for enemy bombing.

(5) U.S. Pat. No. 2,902,784 by D. R. Sukul which relates to indicators disposed on doors of hotel rooms and similar accommodations, and has particular reference to a manually rotatable room service indicator of improved construction and convenience.

(6) U.S. Pat. No. 3,159,827 by Hall, et al., which relates to signaling devices and more particularly to signaling devices for imparting information to callers at the entrance to dwelling houses or other buildings.

(7) U.S. Pat. No. 3,228,020 by Gassenheimer, et al., which relates to a signaling system and more particularly to a signaling system for hotels, motels and like establishments.

(8) U.S. Pat. No. 3,258,763 by Klein, et al., which relates to multiple position relays having at least three separate stable switching positions and more specifically relates to status indicators for visually displaying multiple-position signals.

(9) U.S. Pat. No. 3,705,422 by Savey, which relates to a panel room status indicator system and room unit thereof.

(10) U.S. Pat. No. 3,797,009 by Crudgington, et al., which relates to a room status system for hotels.

(11) U.S. Pat. No. 3,975,724 by Schultz, which relates to a room status signaling system employing a plurality of separate signaling circuits employing the internal telephone wiring so that a separate signaling circuit is provided for each room. The plurality of signaling circuits terminate at a central location or board having an indicator such as a lamp for displaying the status of a room. Each signaling circuit not only includes an indicator lamp in series, but further terminates at its opposite end to a switch located at the room. The switch includes a housing having a slot adapted to receive a coin and a chamber for holding the coin after it has been inserted into and through the slot. The chamber further includes a pair of fixed spaced apart contacts which are insulated from each other and which are mechanically and electrically connected together when the coin is held in the chamber of the holder. The signaling system further includes a coded key which is insertably received through the slot so as to project into the chamber to displace the coin from the chamber and break electrical and mechanical connection between the connectors. The presence of either the metallic coin or the insulated key completes or breaks an electrical circuit in the signaling system so as to energize or de-energize the lamp or respective indicators at the central location.

(12) U.S. Pat. No. 4,003,040 by Browand, which relates to a flashing door sign comprises a casing having illuminable house numbers at the front thereof. The casing contains red and white light bulbs which are selectively operable by a switch located inside of the house; the switch has positions corresponding to a continuous white light, flashing white light, and flashing red light to indicate an emergency. The switch must be moved in a non-rotational direction to enter the emergency position.

(13) U.S. Pat. No. 4,686,505 by Vanderburg, which relates to an emergency lighting apparatus which is activated by a homeowner in the event of an emergency. Transparent house numbers are illuminated from behind, while a strobe light is flashed. The illuminated numbers are mounted on the face of a first compartment and the strobe light is mounted within a second compartment. The two compartments are surrounded by a water-tight housing which might be readily attached to a building.

(14) U.S. Pat. No. 4,854,061 by Khoshkish, which discloses a door sign device including an actuator mounted on the inner door surface of a door that has inner and outer door surfaces so that a user can move the actuator between first and second actuator positions, and a follower mounted on the outer door surface so that the follower can be moved between first and second follower positions that each correspond to a respective one of the first and second actuator positions. Coupling components are included for coupling the actuator to the follower magnetically so that the follower follows actuator movement, and indicator components responsive to the follower being in the first follower position indicate that a predetermined sign applies.

(15) U.S. Pat. No. 4,901,461 by Edwards, et al., discloses a system for identifying a house which includes a display unit mounted outside the house, the display unit housing a plurality of bulbs for back lighting a translucent panel with numbers affixed thereto. A combined control module/power pack is within the house and in electrical communication with the display unit. The power pack includes an electronic control circuit for selectively providing a plurality of modes of operation, including automatic operation (e.g. the display unit goes on at dusk and off at dawn), manual operation, blinking white display, and blinking red display, plus an override in any mode, including an off mode. The blinking display signals an emergency condition. A separate status display enables a home owner to give a status signal to a person outside the house to give warning of such thing as the presence of a home invader, for example.

(16) U.S. Pat. No. 4,929,936 by Chang, et al., which discloses a lighted sign, particularly useful for identifying a residence number on a street, has a display panel having a plurality of aligned numbers illuminated by LED's which are selectively programmable by the user to display the proper house number. In the event of an emergency, the sign is changeable to an emergency mode in which the numbers flash intermittently, and the LEDs change from a first color to a red color indicating the emergency. The sign is activated manually or by means of a photocell, and the emergency condition may be actuated by a manual switch for a remote transmitter. The device may also be used to activate other emergency alert signals, such as an audible signal or a signal transmitter over phone lines.

(17) U.S. Pat. No. 5,210,520 by Housley, et al., which discloses a programmable doorbell system including a battery-powered doorbell control for connection in series with an existing doorbell pushbutton in a residential doorbell circuit. In a first embodiment, the doorbell control has a visual LCD display which can display one of a plurality of messages. A manual switching mechanism is provided for selecting one of the messages for display. By utilizing an internal time of day clock, the residence occupant can program the control for a time interval during which the normal doorbell is disconnected from the doorbell switch. During this time interval, the doorbell control sounds a tone alarm and displays the selected message if the doorbell switch is pressed by a visitor. A second embodiment is disclosed which utilizes a digital record/playback circuit to record an audible announcement by the occupant and store the recorded announcement as digital signals. An audible announcement is generated from the stored digital signals when the doorbell pushbutton is pressed by a visitor.

(18) U.S. Pat. No. 5,673,016 by Lutes, which discloses a multifunction visitor information system for use in association with a building structure including an electrical system, intercom system, door bell system, security system and telephone system, the apparatus comprising: a central control unit formed in a planar configuration with an essentially hollow interior, the control unit being couplable to a desired mounting surface, the control unit including at least one light, a liquid crystal display panel including means for displaying a plurality of different messages for viewing by visitors to a building structure, the liquid crystal display panel and each light being electrically coupled to the electrical system of a building structure; and a plurality of function buttons being positioned within the display unit and operatively coupled to the liquid crystal display panel, the function buttons permitting users to send a plurality of different coded sequences to the panel thereby causing different messages to be displayed on the panel.

(19) U.S. Pat. No. 6,236,303 by Wagner, et al., discloses a system which replaces conventional “do not disturb” and “maid service” or “housekeeping” signs in hotel guestrooms. The system comprises means for allowing a hotel guest to choose, from within the hotel room, a message to convey to hotel staff and others such as “do not disturb”. The message is expressed by indicators housed within assemblies located outside of the hotel room, which are visible to passers-by. The system may also convey such messages to a more remote location such as a housekeeping office and the switch may be activated remotely.

(20) U.S. Pat. No. 6,731,200 by Wagner, et al., discloses a system which replaces conventional “do not disturb” and “maid service” or “housekeeping” signs in hotel guestrooms. The system comprises means for allowing a hotel guest to choose, from within the hotel room, a message to convey to hotel staff and others such as “do not disturb”. The message is expressed by indicators housed within assemblies located outside of the hotel room, which are visible to passers-by. The system may also convey such messages to a more remote location such as a housekeeping office and the switch may be activated remotely. The accompanying drawings, which are included to provide a further understanding of the invention and are incorporated in and constitute a part of this specification, illustrate embodiments of the invention and together with the description serve to explain the principles of the invention.

Embodiments of the invention are directed to a notification assembly configured to provide a notification to a first user based on preprogrammed or non-preprogrammed notification messages from a second user. The notification assembly may be utilized in a wide variety of environments including hotels, motels, single family homes, mobile homes, apartments, offices, vehicles, prisons, and other places where notifications are desired.

In one aspect of the invention, the notification assembly includes an input assembly configured to allow a user to program or indicate a message to be delivered and an output assembly in communication with the input assembly. In a preferred embodiment, the input assembly is in a separate geospatial location from the output assembly, e.g., one is on the inside of the room or structure and one is on the outside of the room or structure. The notification assembly includes a communication for communicating to another external system, device or between the input assembly and output assembly, e.g., wireless or wired control and power unit. Moreover, in addition to or alternatively the system may have wired control.

The wireless system may include any type of wireless communication or transfer of information between two or more points that are not connected by an electrical conductor, e.g., Bluetooth, Wi-Fi, WiGig, ZigBee, LE Bluetooth, WirelessHART, MiWi, 6LoWPAN, and any IEEE communication standards including, but not limited to 802.15.1, 802.15.4, 802.11, 802.11a, 802.11b, 802.11g, 802.11n, 802.11ac, and the like. Moreover, near Field Communication (NFC) may be used, e.g., ECMA-340, ISO/IEC 18092, ISO/IEC 18092/ECMA-340, ISO/IEC 21481/ECMA-352, ISO/IEC 1443 both Type A and Type B, FeliCA and others. Moreover, passive or active RFID may be utilized. The wired control may include Firewire, USB, Lightning, PCI Express, Thunderbolt, eSATA/SATA, LAN and the like. The IEEE standards may include IEEE 1394 and 802.3.

The output unit also includes one or more devices configured to communicate with a user. These devices include one or more of speakers, indicator lights, displays and audio streams. For example, the speakers may include internal or external speakers, analog output, digital output, e.g., PCM/FCM, optically encoded output, internal or external amplification, transmission of data to another device, e.g., playing audio through a user's mobile communication device or other device via wireless communication, magnetic, piezoelectric, and other mechanisms.

The indicator lights may be one or more LED indication lights or other lights configured to display any color or pattern at different states or times. In addition, the display may include any type of display, i.e., LED, LCD, PDP, touch display, and the like. Moreover, the indicator lights may include VFD indication or communication to another external display may also be done. The external display may be another mobile device.

The output assembly may be configured to output audio and/or visual communications. These communications may include any audio and/or visual patterns, music, language, messages played, indicated or transmitted via any one or more control options, e.g., pre-programmed, user programmed, user customizable, user recordable, factory selectable, e.g., jumpers, fuses, hardware population options, switches and the like. In addition, the volume output may be preconfigured.

The notification assembly includes a power mechanism or source including wall power, battery power, and external power sources. The wall power may be grounded or not, internal offline supply or external offline supply and the like. The battery power may include parallel, series, or a parallel-series combination with wall power or independently. The charging may or may not be an option on assembly. Any type of battery source may also be used including nickel cadmium, nickel-metal hydride, lithium ion, lithium polymer, lithium iron phosphate, combinations of other metals including cobalt, manganese and other battery sources may be used. The external sources of power may include wall/grid power, USB ports from other devices or wall/grid power, inductive, microwave, or other wireless transfer methods, energy harvesting, e.g., thermal vibration and/or photovoltaic along with other external sources.

The input side may be configured with a variety of input mechanisms, e.g., voice controls, physical tactile inputs, capacitive inputs, motion sensor inputs, gesture control inputs, and touch controls. The capacitive inputs may be arranged directly on a PCB, raised on mezzanine board, or arranged between pad and on a user interface, e.g., spring or metal bump. Motion sensor inputs and gesture control inputs may be utilized. These motion sensor inputs and gesture control inputs include infrared or visible spectrum sensors, motion tracking/recognition sensors, and/or gesture tracking or recognition sensors. The voice control may be implemented with internal or external microphones, and controlled via voice through encoded data packets transferred via another method such as wireless or wired control. Touch controls may include resistive or capacitive touch overlay, standalone or display touch controls.

The notification apparatus has a number of different functionalities including a sleep mode, the ability to have different modes automatically triggered, e.g., based on times of the day, before and after a predetermined or programmed event or some other predetermined criteria, and the ability to be used as an alarm. In one embodiment, the automatically triggered modes may sense a user leaving a room and set a predetermined message, e.g., House Keeping sign or signal to on, after leaving room. Moreover, the message may be disabled if not taken care of already once user is within some specified location of the room. In another embodiment, an alert or message, e.g., privacy please, may be set from a preprogrammed time range, e.g., midnight to 10:00 AM. In another embodiment, an alarm and/or message may occur upon a predetermined event, e.g., forced entry, accidental entry, time, and the like. In another embodiment, a message can be sent over a network with any of the foregoing features.

Reference will now be made in detail to an embodiment of the present invention, an example of which is illustrated in the accompanying drawings.

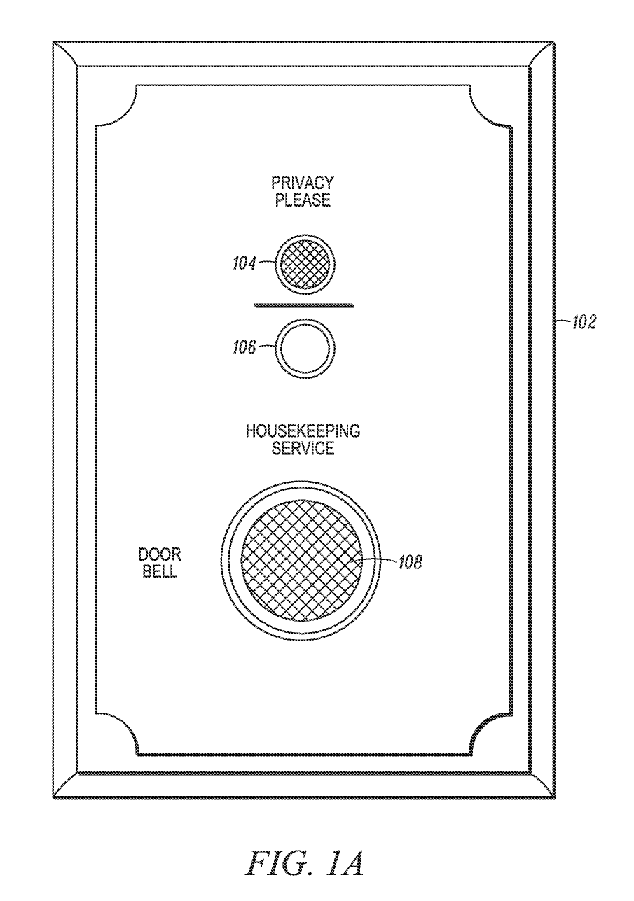

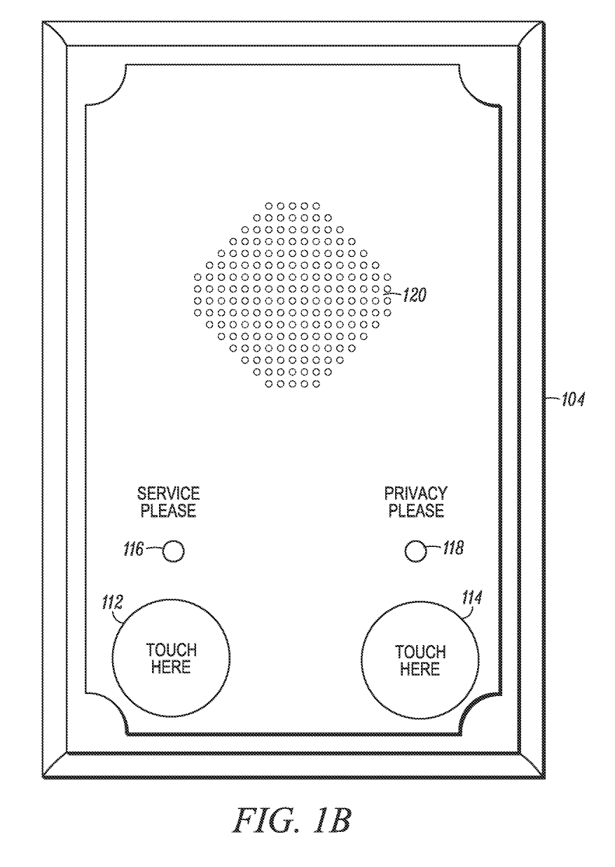

FIG. 1A illustrates an exemplary view of a first interface of a notification assembly according to an embodiment of the invention.

Referring to FIG. 1A, a first interface 102 of a notification assembly is shown. In an embodiment, the first interface 102 may be the entirety or part of a panel for the outside of a room (e.g., the panel placed at or near a door of the outside of a room at a hotel or other establishment) to indicate information inside the room and/or to communicate/present communication with an occupant of the room.

The first interface 102 may include a first indicator 104 and second indicator 106. The first indicator 104 and the second indicator 106 are shown in FIG. 1A as LED lights, but the first indicator 104 and the second indicator 106 may be other indicator lights or displays. The lights may be different or same color light emitting diodes (LEDs). The display may be any type of digital display including TFT, LCD, LED, OLED and others. The first indicator 104 and the second indicator 106 may be of the form of speakers or other forms of sound output or other communication mechanism for informing a human, machine, or others. In an embodiment, the first indicator 104 and the second indicator 106 may indicate, respectively, that the occupant of a room requests privacy and housekeeping service.

The first interface 102 also includes an input 108. The input 108 may be activated by applying pressure to the input (e.g., pressing on the input). In an embodiment, the input 108 may be a door bell. However, the input 108 may also be a motion sensor, heat sensor, or other type of sensor.

In an embodiment, the first interface 102 may also include additional indicators or inputs as needed.

In an embodiment, the first indicator 104, second indicator 106, and the input 108 are communicatively coupled to a processing module of the notification assembly. For example, the first indicator 104 and the second indicator 106 may be coupled to the processing module as the output of the processing module to indicate that privacy and/or housekeeping service is needed (e.g., the occupant of the room has provided input of the privacy and/or housekeeping service request through a second interface (e.g., within the room), where the second interface is also communicatively coupled to the processing module). Similarly the input 108 may be coupled to the processing module as the input of the processing module for producing a corresponding output (e.g., a doorbell ring) at a second interface, where the second interface is also communicatively coupled to the processing module for producing the output. An exemplary embodiment of the second interface will be discussed with respect to FIG. 1B.

FIG. 1B illustrates an exemplary view of a second interface of a notification assembly according to an embodiment of the invention.

Referring to FIG. 1B, a second interface 104 of the notification assembly is shown. In an embodiment, the second interface 104 may be the entirety or part of a panel for the inside of a room (e.g., the panel placed at or near a door of the inside of a room at a hotel or other establishment) to allow the occupant to communicate information to outside the room (e.g., privacy and/or housekeeping service requests) and/or to present communication with others (e.g., guest, service staff, etc.) outside the room. In an embodiment, the second interface 104 may be communicatively coupled, through a processing module, to the first interface 102 for such communications.

The second interface 104 includes a first input 112 and second input 114 and corresponding third indicator 116 and fourth indicator 118. The first input 112 corresponds to the third indicator 116 and second input 114 corresponds to a fourth indicator 118. The third indicator 116 and the fourth indicator 118 may be LED lights, but the third indicator 116 and the fourth indicator 118 may be other indicator lights or displays. The lights may be different or same color light emitting diodes (LEDs). The display may be any type of digital display including TFT, LCD, LED, OLED and others. The third indicator 116 and the fourth indicator 118 may be of the form of speakers or other forms of sound output or other communication mechanism for informing a human, machine, or others. In an embodiment, the third indicator 116 and the fourth indicator 118 may indicate, respectively, the activation state of the first input 112 and the second input 114. For example, the occupant of a room may have activated or deactivated the first input 112 and/or the second input 114 for requesting privacy and housekeeping service. As such, the activation state of the third indicator 116 and the fourth indicator may, respectively, light on (for an LED) if the respective request (privacy and/or housekeeping service) is activated and light off if the respective request is deactivated.

The second interface 104 also includes an output 120. In an embodiment, the output 120 may be a speaker or other type of output communicatively coupled, through a processing module or directly, to an input (e.g., the input 108) of the first interface 102. For example, when a visitor pressing the input 108 (as a doorbell) of the first interface 102 position outside of a room, the doorbell would be played through the output 120 (as a speaker) of the second interface 104 positioned inside the room.

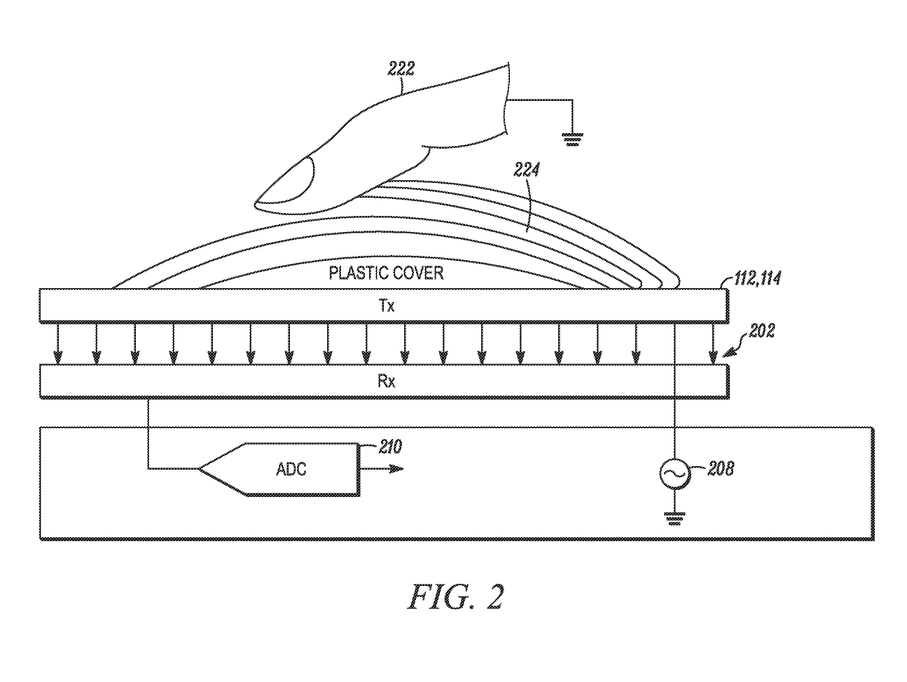

The first input 112 and the second input 114 may each consist of a switch for switching between an activation and a deactivation state for the respective input as discussed above. In an embodiment, the first input 112 and the second input 114 may each consist of a capacitive switch mechanism for sensing a touch of a human (or other touches). For example, each of the first input 112 and the second input 114 may consist of a capacitive sensor (e.g., a single channel capacitive proximity sensor by implemented by an Azoteq P/N IQS127D-00002-TSR chip). Other types of sensor may also be used (e.g., thermal sensors, sound sensors, motion sensors, etc.). The capacitive switch mechanism is further discussed with respect to FIGS. 2-6 below. In another embodiment, the first input 112 and second input 114 may be electrical, mechanical, or other types of switches as known now or may be later derived.

FIG. 2 illustrates an exemplary view of an input for a notification assembly according to an embodiment of the invention.

Referring to FIG. 2, the input may be one of the first input 112 or the second input 114. Here, the input works by a capacitive switch mechanism. In an embodiment, the input is covered by a plastic cover separating the outer portion of the input (e.g., the portion on the face of the second interface 104) and an inner portion of the input (e.g., the portion beneath the face of the second interface 104). An electric field 202 is generated at the inner portion of the input by a source 208 coupled to the inner portion of the input. The source 208 may be an excitation signal source at a predetermined frequency (e.g., 250 kHz). The generated electric field 202 at the inner portion of the input includes a fringe field 224 at the outer portion of the input (e.g., an electric field spill over from the generated electric field 202).

In an exemplary operation of the capacitive switch mechanism, no physical switch mechanism or contact is needed to change the activation state of the corresponding first input 112 or second input 114 (e.g., to adjust a state of the switch from a first state to a second state). Further, the capacitive switch mechanism does not have a defined “on” and “off” position denoting the activation state or the change in the activation state of the corresponding first input 112 or the second input 114. Rather, a change in the electric field may be detected and a dynamic threshold of the change in the electric field may be defined to as an indication of a switch in the activation state.

In further discussing the exemplary operation of the capacitive switch mechanism, it is assumed that no human interaction will enter and exit the fringe field 224 (and thereby a change in the electric field 202) faster than the time between excitation bursts of the excitation signal by the source 208 (e.g., every 4 microseconds for an excitation signal of 250 kHz). If something is detected to enter and exit or change the electric field 202 and/or fringe field 224 in a faster way, it is assumed to be noise, environmental effects, or something else and the baseline is adjusted. When a finger 222 or other conductive objects enters the fringe field 224, the fringe field 224 (and the electric field 202) will be reduced due to the conductive property of the finger 222 acting as a capacitive sink (e.g., drawing a current from the fringe field 224 (and the electric field 202)). This change in the electric field 202 would be measured by a signal monitor 210. In an embodiment, the signal monitor 210 may be coupled to or include an analog-to-digital converter (ADC) (e.g., a delta-sigma ADC, a successive approximation ADC) for converting the measured analog signal or change in the electric field 202 to a digital measurement for further processing (e.g., by a digital processing module, e.g., a microcontroller).

Further with respect to the signal monitor 210, the signal monitor 210 is configured to measure the electric field 202. For example, when the source 208 generates an electric field 202 at a predetermined frequency (e.g., 250 kHz), the signal monitor 210 should measure a signal from the electric field 202 at the predetermined frequency, assuming there is no disturbance to the electric field 202. However, when a finger 222 or other capacitive sink (e.g., an electronic stylus, a conductive glove) disturb the electric field 202 (through disturbing the fringe field 224), the signal monitor 210 is expected to measure a reduced electric field 202 due to the disturbance by the finger 222 or the other capacitive sink, for the period when the finger 222 or the other capacitive sink is actually within the fringe field 224. In an embodiment, the amount of disturbance leading to the reduced electric field 202 may be measured as an amount proportional to the baseline electric field (e.g., the measured electric field 202 at the signal monitor 210 due to the excitation signal by the source 208 when there is no disturbance). The measured electric field may be sent to a processing module (e.g., including a microcontroller). The ultimate state of the first input 112 or the second input 114 may be determined based on internal logic and software using the software (e.g., based on the level of the measured electric field, a pattern (e.g., duration of the change in the measured electric field), etc.).

In contrast to a mechanical switch, which may have an actual metal plate as the detection element, when the metal plate is moved into position, contact is made with another plate, thereby completing a circuit. As such, the action and sensing for the mechanical switch are always the same; the mechanical switch is either pressed, or not pressed. The capacitive switch mechanism here does not have any specific “on” and “off” switching that is defined. The detected action of the capacitive switch mechanism is a measured level of the resulting electric field 202 by the signal monitor 210. As such, the capacitive switch mechanism allows for dynamic definition of the activation/deactivation of the switch as well as the definition and detection of other activities of the switch through software.

In an embodiment, the software may be programmed to define certain patterns of the measured electric field 202 over time as a given activity. For example, a period of undisturbed electric field measurement followed by a period of reduced electric field measurement consistent with the touch of a human finger (e.g., a fraction of a second to a few seconds) may indicate that this pattern is consistent with an activation or deactivation of the corresponding input (and a reversal of the previous activation or deactivation state of that corresponding input) and may be programmed into the software the same. In another example, any relatively short period of reduced electric field measurement (e.g., on the order of microseconds or less) may indicate noise, accidental activation, or other events inconsistent with a human's purposeful activation of the input; such pattern may be programmed to be ignored by the software. In another example, a prolong period of reduced electric field measurement (e.g, tens of seconds to minutes or more) may indicate an obstruction affecting the electric field 202 that is not a purposeful activation of the input by a human, an updated threshold of the undisturbed electric field 202 (e.g., due to the environment, weather, or other factors affecting the electric field 202 generally), a malfunction of the input and/or other associated components; such pattern may be programmed to be ignored by the software or may also raise a warning or error with respect to possible malfunction.

In another embodiment, the software may include a neural network used for detection by training with known patterns of usage. For example, the software may be trained with a pattern of the electric field 202 in a known usage (e.g., a human pressing the capacitive switch mechanism, anomalies not related to a human pressing (e.g., a fly or other anomaly having activity around the capacitive switch mechanism)). The neural network will be able to group the trained patterns of the electric field 202 with accuracy with sufficient training.

Upon a determined activation of the first input 112 or the second input 114, the corresponding third indicator 116 or fourth indicator 118 may be activated or deactivated. Further, the corresponding first indicator 104 or second indicator 106 on the first interface 102 may also be activated or deactivated. Each of the first indicator 104, second indicator 106, third indicator 116, and the fourth indicator 118 may be communicatively coupled to the processing module and be activated or deactivated by the same processing module.

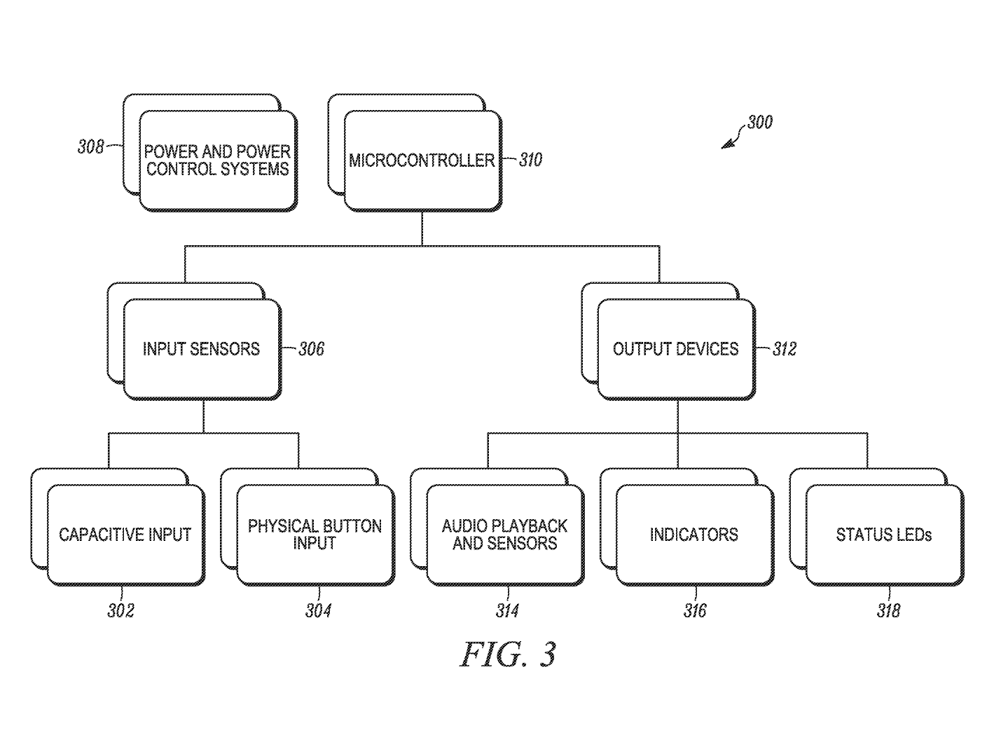

FIG. 3 illustrates an exemplary schematic of a notification assembly according to an embodiment of the invention.

Referring to FIG. 3, the notification assembly 300 includes one or more capacitive inputs 302 and one or more physical button inputs 304 electrically coupled to one or more (and corresponding to the capacitive inputs 302 and physical button inputs 304) input sensors 306. The input sensors 306 are electrically coupled to a microcontroller 310. The microcontroller 310 is electrically coupled to one or more output device 312. The output devices 312 may include and/or are electrically coupled to audio playback and sensors 314, indicators 316 and status LEDs 318. The notification assembly 300 further includes power and power control systems 308 for supplying power to the various components of the notification assembly 300.

In an embodiment, the capacitive inputs 302 may correspond to the first input 112 and the second input 114 of the second interface 104. The physical button input 304 may correspond to the input 108 of the first interface 102. Here, it is noted that the notification assembly 300 may take input from respectively the first interface 102 and the second interface 104 and may perform processing on the inputs simultaneously and using the same processing components (e.g., input sensors 306 and microcontroller 310).

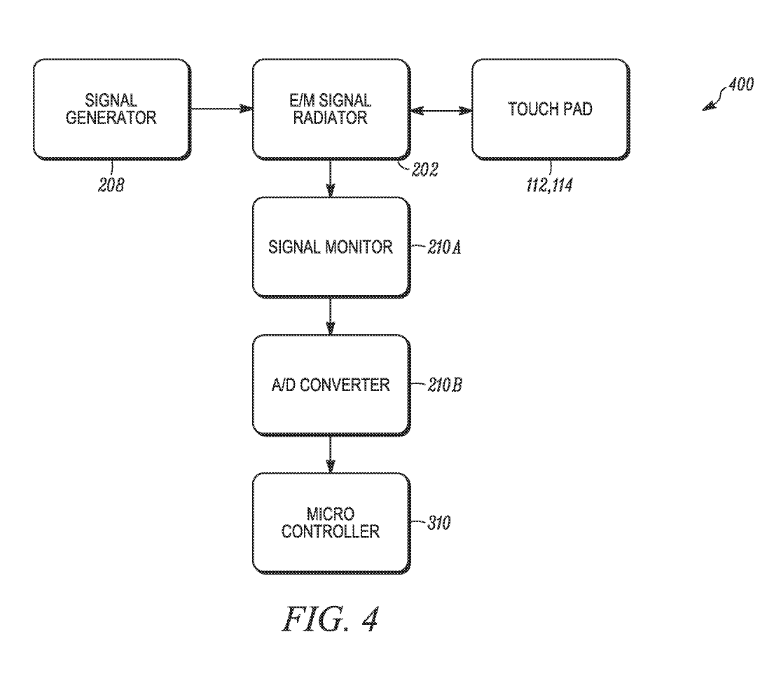

In an embodiment, the input sensors may include an Azoteq P/N IQS127D-00002-TSR chip for processing the capacitive inputs, which will be further discussed below with respect to FIGS. 4 and 6. In an embodiment, the physical button inputs 304 may bypass the input sensors 306 and be directly coupled to the microcontroller 310 or the outputs devices 312 or even the audio playback and sensors 314 directly (e.g., for a physical button input 304 of a doorbell).

In an embodiment, the microcontroller 310 may include a 18F14K50 chip. The microcontroller 310 is configured to receive inputs (e.g., physical button inputs 304 and/or capacitive inputs 302), either directly or through the input sensors 306 if the input is not in a form suitable for processing by the microcontroller 310. The microcontroller 310 is further configured to perform the relevant processing, and activate the appropriate output devices 312. For example, with respect to the capacitive inputs 302, the microcontroller 310 may received digitalized version of the input by the input sensors 306 and perform suitable processing on the inputs. As discussed above with respect to FIG. 2, the microcontroller 310 may include software for interpreting the digitalized input representing the value of a variable (e.g., the measured electric field 202) leading to the activation or deactivation of a state of another variable that may be related to an output (e.g., the status of a status LED 318). After performing such processing by the software, the microcontroller 310 may then send the output to the appropriate output devices 312.

In an embodiment, the output devices 312 may include one or more of a Nuvoton I2130YYR or other audio chip for controlling a speaker or other audio playback and sensors 314. The output devices 312 may further include (or be bypassed) for outputs such as indicators 316 or status LEDs 318, which may be LEDs that are controlled directly by the microcontroller 310.

In an embodiment, the power and power control systems may include a power opamp, power regulator (e.g., LTC300, LT1761, LT1761ISS-3.3#PBF) for controlling power from a power source to supplying power to the various components of the notification assembly 300.

FIG. 4 illustrates an exemplary schematic of a capacitive switch for a notification assembly according to an embodiment of the invention.

Referring to FIG. 4, the capacitive switch 400 includes a touchpad (e.g., first input 112 and second input 114), an electromagnetic signal radiator 202, a signal generator 208, a signal monitor 210A, an analog to digital converter (ADC) 210B, and a microcontroller 310. It is noted that the components here have been described above, but is described with respect to FIG. 4 here with particular emphasis to only the capacitive switch 400 for further explanatory purposes.

For example, the touchpad is referred to as the first input 112 or the second input 114 with reference to FIG. 1B; it is generally an accessible place for a human finger and is set up to provide a fringe field upon the generation of an associated electric field that is generally not accessible by the human finger (e.g., separated by a plastic cover such that electric field is not physically accessible by the human finger). The electric field may be generated by signal generator 208 and the electromagnetic signal radiator 202 such that the electric field generated would have a fringe field on the accessible side of the separation. For example, the electromagnetic signal radiator may be of a form of a plate capacitor aligned beneath the separator such that the fringe field could bleed through the non-conductive separator on the accessible side. With respect to the signal generator 208, the signal generator 208 may generate an excitation signal at a predetermined frequency (e.g., 250 kHz).

The electromagnetic signal radiator 202 may be electrically coupled to the signal monitor 210A (either directly by wire or through other means of detecting the electric field). In an embodiment, the signal monitor 210A measures the electric field in analog, and the analog electric field measurement is converted to digital by ADC 210B. In an embodiment, the signal monitor 210A and the ADC 210B may be performed by the same component (e.g., input sensors 306). The digitalized electric field measurement is sent to the microcontroller 310 for processing.

As discussed above with respect to FIG. 2, the microcontroller 310 is configured to process programmed instructions that defines certain patterns of the measured electric field over time as a given activity. For example, activation and deactivation of certain status lights (e.g., for privacy or housekeeping service) may be detected by detecting a touch of a human finger upon the touchpad 112, 114. The microcontroller 310 may process a pattern of the measured electric field and match the pattern to algorithms or known patterns for the measured electric field and the activate or deactivate the corresponding status lights upon determination (e.g., through the indicators 306 or the status LEDs 308).

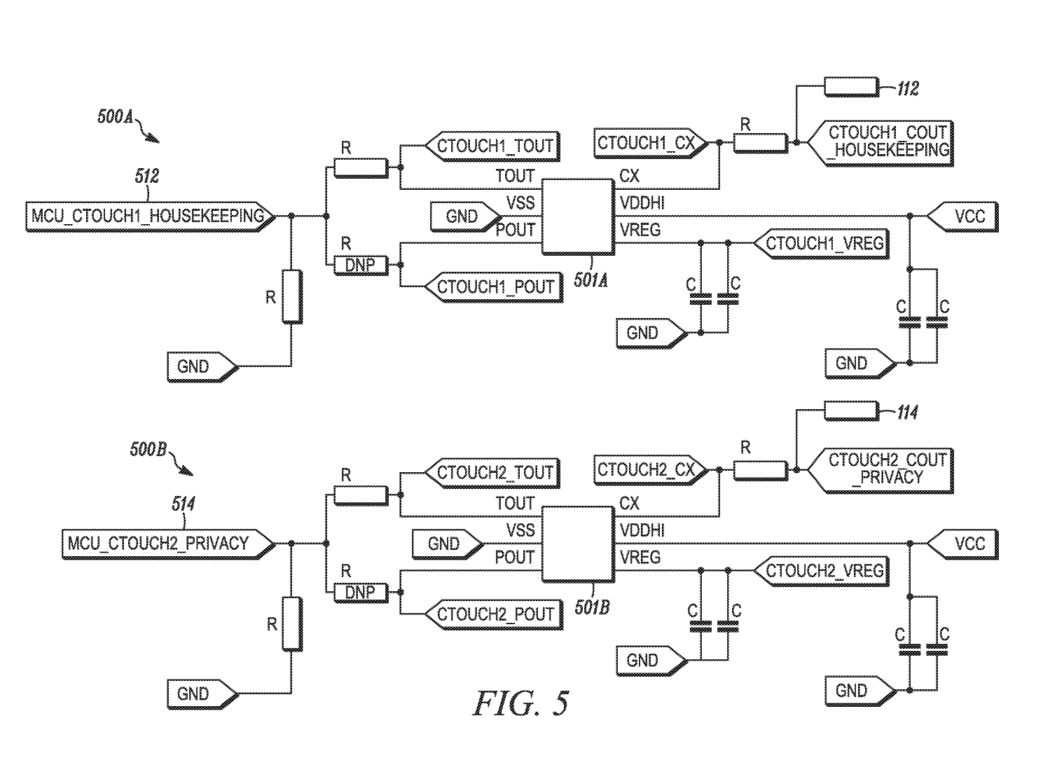

FIG. 5 illustrates an exemplary schematic of a capacitive switch for a notification assembly according to an embodiment of the invention.

Referring to FIG. 5, the capacitive switches 500A (for a housekeeping indicator) and 500B (for a privacy indicator) includes capacitive inputs 112 and 114, respectively, chips 501A and 501B, respectively, for a combination of signal generator, a signal monitor, and an ADC, and outputs 512 and 514, respectively, to a microcontroller (e.g., microcontroller 310).

In an embodiment, the capacitive inputs 112 and 114 are taken at an opposite side of a electromagnetic signal radiator (e.g., electromagnetic signal radiator 202) that has the accessible fringe field for the user. The capacitive inputs 112 and 114 are electrically coupled to an input to chips 501A and 501B, respectively. The chips 501A and 501B may be a Azoteq P/N IQS127D-00002-TSR chip or other chips that include functionality of a signal generator, a signal monitor, and an ADC. For example, the signal generator may send an excitation signal (e.g., an impulse signal) at a predefined frequency that is much faster than human reaction time to press the capacitive switch and is represented by an electric field generated at the capacitive input. The electric field is then measured by the signal monitor on the same chips 501A and 501B. The measured electric field is digitalized by the ADC and is outputted to the microcontroller 310 through the outputs 512 and 514, respectively.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A notification assembly, comprising:
an input interface including one or more capacitive switches;
an output interface including one or more indicators each corresponding to one of the capacitive switches; and
a processor coupled to the capacitive switches and the indicators and configured to process an input of the capacitive switches and send an output to the indicators,
wherein the input interface is placed at a distance from the output interface.

2. The notification assembly of claim 1, wherein each of the capacitive switches comprises:
a signal generator configured for generating an electric field about an electromagnetic signal radiator, the electric field includes a fringe field; and
a signal monitor configured for measuring a disturbance of the electric field.

3. The notification assembly of claim 2, wherein the each of the capacitive switches further comprises a touchpad separated into an inner portion and an outer portion by a separator, the outer portion is accessible to a user, wherein the electric field is substantially generated within the inner portion, and wherein the fringe field is substantially within the outer portion.

4. The notification assembly of claim 2, wherein the fringe field is disturbed by a capacitive sink.

5. The notification assembly of claim 2, wherein the each of the capacitive switches further comprises an analog-to-digital convertor (ADC) configured for converting a measurement of the electric field by the signal monitor into a digital signal, wherein the digital signal is used by the processor as the input of the each of the capacitive switches.

6. The notification assembly of claim 1, wherein the processor is configured to process an activation state of the output by a pattern of the input of the capacitive switches over a time period.

7. The notification assembly of claim 6, wherein the processor is configured to process a reversal of the activation state of the output by a pattern of the input of the capacitive switches over a time period, wherein the pattern is representative of an intentional act of a user over an input of the capacitive switches.

8. The notification assembly of claim 4, wherein the capacitive sink comprises one of a finger of a user, an electronic stylus, or a conductive glove.

9. The notification assembly of claim 1, wherein the input interface is placed at an interior of a room, and wherein the output interface is placed at an exterior of the room.

10. A method of notification, comprising:
receiving an input from one or more capacitive switches of an input interface;
processing, using a processor coupled to the capacitive switches, the input of the capacitive switches; and
transmitting, using the processor, an output to one or more indicators of an output based on and corresponding to the input of the capacitive switches,
wherein the input interface is placed at a distance from the output interface.

11. The method of claim 10, wherein the receiving the input from the capacitive switches comprises:
generating an electric field, by a signal generator, about an electromagnetic signal radiator, the electric field includes a fringe field; and
measuring a disturbance of the electric field using a signal monitor.

12. The method of claim 11, wherein the each of the capacitive switches further comprises a touchpad separated into an inner portion and an outer portion by a separator, the outer portion is accessible to a user, wherein the electric field is substantially generated within the inner portion, and wherein the fringe field is substantially within the outer portion.

13. The method of claim 11, wherein the fringe field is disturbed by a capacitive sink.

14. The method of claim 11, wherein the receiving the input from the capacitive switches further comprises converting a measurement of the disturbance of the electric field by the signal monitor into a digital signal, wherein the digital signal is used by the processor as the input of the each of the capacitive switches.

15. The method of claim 10, wherein the processing, by the processor, comprises processing an activation state of the output by a pattern of the input of the capacitive switches over a time period.

16. The method of claim 15, wherein the processing, by the processor, further comprises processing a reversal of the activation state of the output by a pattern of the input of the capacitive switches over a time period, the pattern representative of an intentional act of a user over an input of the capacitive switches.

17. The method of claim 13, wherein the capacitive sink comprises a finger of a user, an electronic stylus, or a conductive glove.

18. The method of claim 10, wherein the input interface is placed at an interior of a room, and wherein the output interface is placed at an exterior of the room.

19. A notification assembly, comprising:
an input interface including one or more capacitive switches;
an output interface including one or more indicators each corresponding to one of the capacitive switches; and
a processor coupled to the capacitive switches and the indicators and configured to process an input of the capacitive switches and send an output to the indicators,
wherein the input interface is placed at a distance from the output interface,
wherein each of the capacitive switches comprises:
a signal generator configured for generating an electric field about an electromagnetic signal radiator, the electric field includes a fringe field;
a touchpad separated into an inner portion and an outer portion by a separator, the outer portion is accessible to a user, wherein the electric field is substantially generated within the inner portion, and wherein the fringe field is substantially within the outer portion;
a signal monitor configured for measuring a disturbance of the electric field; and
an analog-to-digital convertor (ADC) configured for converting a measurement of the disturbance of the electric field by the signal monitor into a digital signal, wherein the digital signal is used by the processor as the input of the each of the capacitive switches.

20. The method of claim 19, wherein the input interface is placed at an interior of a room, and wherein the output interface is placed at an exterior of the room.
